(19) United States
(12) Patent Application Publication
(10) Pub. No.: US 2013/0297507 A1
(43) Pub. Date: Nov. 7, 2013

(54) SYSTEM AND METHOD FOR WIRELESS TRANSACTION AUTHENTICATION

(71) Applicant: Robert G. Mechaley, JR., Kirkland, WA (US)

(72) Inventor: Robert G. Mechaley, JR., Kirkland, WA (US)

(73) Assignee: MobileSphere Holdings LLC, Kirkland, WA (US)

(21) Appl. No.: 13/464,262

(22) Filed: May 4, 2012

(51) Int. Cl. G06Q 20/32; H04B 7/00; G06Q 20/40; H04W 12/06

(52) U.S. Cl. 705/44

(57) ABSTRACT

A transaction authentication system uses a mobile unit to connect with a wireless network and with an authentication station using a short-range transceiver. Prior to a transaction, the mobile unit transmits an Identity to an authentication processor using the wireless provider network and receives a Hash and Identifiers therefrom. During a transaction, the mobile unit connects to an authentication station using a short-range air link and transmits its Hash. The authentication station transmits the received Hash to the authentication processor, which confirms the Identity of the mobile unit. If identified, the authentication processor sends a Private Identifier to the authentication station and the mobile unit connects using an air link with the Private Identifier. The authentication station sends a success message if it connects to the mobile unit using the Private Identifier air link. A device authentication message is sent to a transaction processor to process the requested transaction.

### BACKGROUND OF THE INVENTION

1. Field of the Invention

The present disclosure relates generally to electronic transactions and, more specifically, to a system and method for transaction authentication using a wireless communication device.

2. Description of the Related Art

Credit card transactions are relatively new in the world of commerce. A traditional credit card transaction was executed with the presentation of a plastic card (i.e., the credit card) that is embossed with the name of the credit card holder, an account number, and an expiration date, as well as other possible information. The back of the card traditionally includes an indelible area for the card owner's signature. To complete a transaction, the credit card was inserted into a mechanical imprinter along with a multi-page carbon copy form. The mechanical device creates an imprint of the embossed surface of the credit card and the consumer signs the imprinted credit card form.

The transaction was generally authenticated by comparing the signature on the back of the credit card with the signature made on the credit card form. In addition, a periodically generated book of invalid credit card numbers was manually searched to determine if the credit card was invalid. Furthermore, some condition might be attached to the transaction, such as a dollar threshold, which would cause the person authenticating the transaction to call a customer service representative of the credit card issuing company to determine whether the transaction could be authenticated or authorized.

As credit cards evolved, a recordable magnetic strip was added to the back of the card. The magnetic strip included encoded data for at least the same information as was embossed into the card and, in some cases, contained additional information. The mechanical credit card imprinting machine was replaced with a magnetic strip reader that allowed the card to be “swiped” to read the encoded data on the magnetic strip. The card reader was connected to a computer server that authenticated or authorized the transaction. The magnetic strip eliminated the step of impressing the card in many cases and reduced or eliminated the need to consult a book of invalid credit card numbers or the need for making an authorization phone call. However, initially, it did not eliminate the process of comparing signatures.

As computer and credit card systems evolved, numeric keypads were added to the magnetic strip reading apparatus such that the signature checking process took a secondary role to the credit card owner entering a number known only to them and the credit card owner. The purchaser would enter a personal identification number (PIN) on a keypad and the PIN data was matched at the credit card owner computer to authenticate the credit card. This process was the beginning of the movement from manual to automatic authentication of the user and subsequent approval of the transaction.

A subsequent generation of plastic cards includes an embedded near-field communication (NFC) chip embedded into the card to augment or replace the magnetic strip. Although not widely used in the U.S., the NFC chip allowed the data that was previously on the magnetic strip, as well as optional additional data, to be read by an NFC reader when the card was placed near the surface of the NFC reader. Thus the step of swiping the magnetic strip is eliminated. However, the authentication mechanism for these transactions still includes the entry of the PIN by the card user. Due to the development of more sophisticated computer systems to analyze the risk of fraud, the entry of PIN data has been eliminated for both the magnetic strip cards as well as for cards with the NFC chip for transactions involving small amounts. The adoption of NFC technology has been slow because of the cost of augmenting or replacing the magnetic strip readers with NFC readers.

While the introduction of NFC chips into credit cards has enabled a new generation of authentication technologies, a more recent development has been the addition of NFC chip functionality into wireless phones. However, the use of the NFC chip in a wireless phone still requires a new NFC reader at the site of the transaction, thus reducing the adoption of this technology.

Therefore, it can be appreciated that there is a significant need for a technique that will permit the simple, reliable, and secure authentication for financial transactions. The present disclosure provides this, and other advantages, as will be apparent from the following detail description and accompanying figures.

### BRIEF DESCRIPTION OF THE SEVERAL VIEWS OF THE DRAWING(S)

FIG. 1 is a diagram illustrating an exemplary system architecture in accordance with the present disclosure.

FIG. 2 is a functional block diagram of a wireless communication device used in the system architecture of FIG. 1.

FIG. 3 is a functional block diagram of an authentication station used in the system architecture of FIG. 1.

FIGS. 4A-4B together form is a data flow diagram illustrating the exchange of messages between various components in the system of FIG. 1.

FIG. 5 is a flow chart illustrating the operation of an exemplary embodiment of the system disclosed herein.

### DETAILED DESCRIPTION OF THE INVENTION

As discussed in the background section, some new wireless communication devices include an NFC chip. While such technology may improve the automation of the authentication process, it requires the introduction of new technology in the form of NFC chips to be installed in wireless communication devices. In contrast, the present invention utilizes the communication functionality already present in many phones. As will be described in detail below, the exchange of data through multiple different communication pathways provides a greater degree of security in the authentication process.

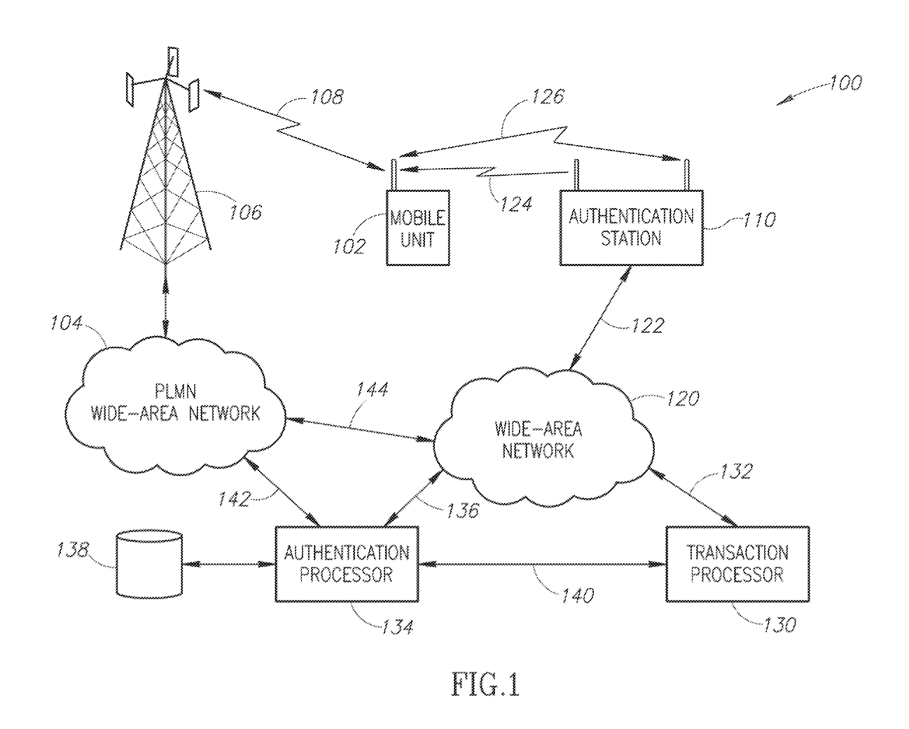

FIG. 1 is an example architecture of a system 100 constructed in accordance with the present disclosure. A mobile unit 102 can communicate with a wide-area network, such as a public land mobile network (PLMN) 104 via one or more base stations 106. The mobile unit 102 establishes a wireless communication link 108 with the base station 106 in a conventional manner. Depending on the particular phone and the particular service provider, the mobile unit 102 uses conventional wide area air link protocols, such as GSM, CDMA, CDMA2000, WiMax, LTE, and the like to communicate with the base station 106 using the respective data capabilities of those networks (e.g. GPRS, EDGE, SMS, MMS, and the like). The PLMN 104 is generically representative of the many wireless service networks presently available. Furthermore, for the sake of clarity, FIG. 1 illustrates only the base station 106. Those skilled in the art will appreciate that the typical PLMN 104 has a large number of base stations distributed throughout much of the U.S. (and in many other countries) to provide a vast area of coverage. The operation of the mobile unit 102 to communicate with the base station 106 and the PLMN 104 is well known in the art and need not be described in greater detail herein except with respect to the specific exchange of data in the authentication process. This will be described in greater detail below.

Although illustrated in FIG. 1 as a phone, those skilled in the art will appreciate that the mobile unit 102 can be implemented in many forms of wireless communication devices, such as smart phones, PDAs, laptop or mobile computing devices, PC tablets, and the like. The system 100 is not limited to cell phones.

FIG. 1 also illustrates an authentication station 110 where a transaction will be authenticated. The authentication station 110 may be commonly implemented in the form of a point-of-sales terminal in a retail store, restaurant, gas station, and the like. However, the authentication station 110 can be any facility at which a commercial transaction can occur. For example, the authentication station 110 can be a ticket dispenser in a train station or public transit facility, an automated DVD rental kiosk in a grocery store, an ATM, or the like. Thus, the authentication station 110 should be broadly construed to be any form of device that can participate in the financial transaction in the manner described below.

The authentication station 110 is coupled to a wide area network (WAN) 120 by a communication link 122. The WAN 120 can be, by way of example, the Internet. However, the WAN 120 may also be a private network. The communication link 122 can be a wired link using protocols, such as TCP/IP, Ethernet, SONET, or the like, fiber-optic link, or a wireless communication link, such as IEEE 802.16D, microwave, or the like, alone or in combination.

In addition to the communication capability with the WAN 120, the authentication station 110 can communicate directly with the mobile unit 102 using two different short-range communication links 122 and 124. The first and second wireless communication links 124-126 may be implemented using known technologies, such as Bluetooth, WiFi, Zigbee, or the like. The operational data exchanged via the first and second wireless communication links 124-126 will be described in greater detail below.

The system 100 also includes a transaction processor 130, which is communicatively coupled to the WAN 120 via a communication link 132. The transaction processor 130 is configured to process the actual financial purchase transactions. It is the transaction processor 130 that approves or rejects the actual financial transactions. For example, if the transaction exceeds the credit limit of the user account, the transaction processor will send a transaction rejection message to the authentication station 110.

An authentication processor 134 is also communicatively coupled to the WAN 120 via a communication link 136. As will be described in greater detail below, the authentication processor 134 is responsible for verifying the identity of the mobile unit 102. The authentication processor 134 can communicate a verification of the identity to the transaction processor 130 via the WAN 120 and the communication links 136 and 132. Alternatively, the authentication processor 134 may be coupled to the transaction processor 130 via a communication link 140. In this embodiment, the communication link 140 may be, by way of example, a local area network (LAN).

FIG. 1 also illustrates a database 138 coupled to the authentication processor 134. As will be described in greater detail below, the database will store and manage identity data for the mobile unit 102 and for other mobile units. Although described herein as the database 138, those skilled in the art will appreciate that any convenient data storage structure may be satisfactorily employed. Thus, a data lookup table, spreadsheet, or other data storage structure may be used to store identity data.

FIG. 1 also illustrates connections between the PLMN 104 and the authentication processor 134. In one embodiment, the PLMN 104 may be connected directly to the authentication processor 134 via a communication link 142. In this embodiment, the communication link 142 may be a LAN connection. Alternatively, the PLMN 104 may be coupled to the authentication processor 134 via a communication link 144 to the WAN 120. In this embodiment, data is exchanged between the PLMN 104 and the authentication processor 134 via the WAN 120.

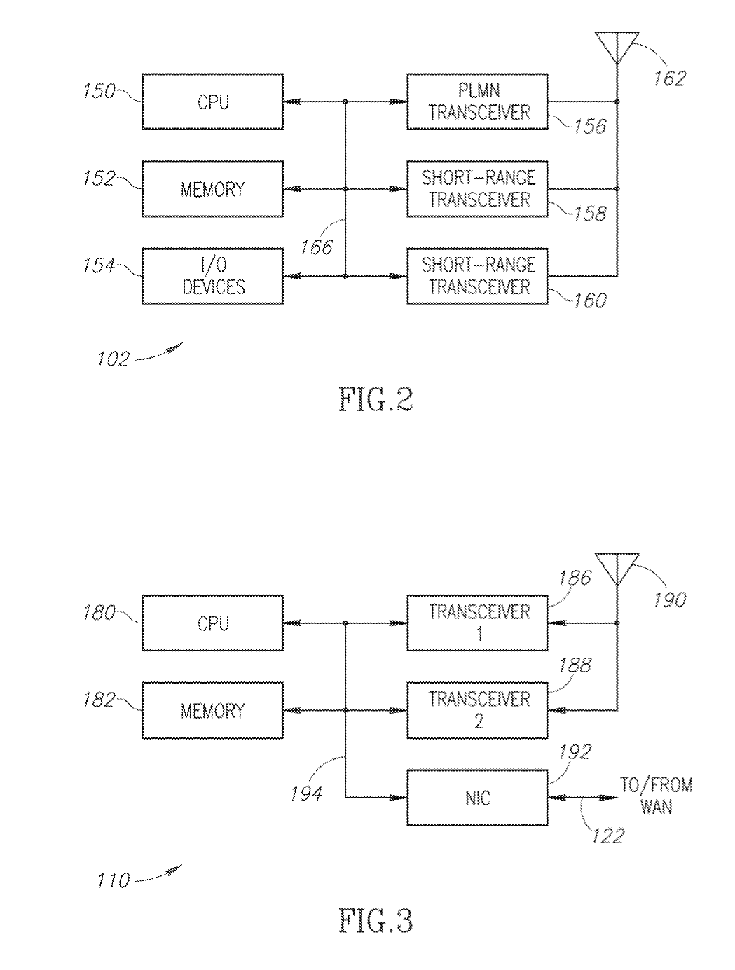

FIG. 2 is a functional block diagram of a generic version of the mobile unit 102. The mobile unit 102 includes a central processing unit (CPU) 150 and a memory 152. The CPU 150 may be implemented by a number of known technologies, such as a microprocessor, microcontroller, ASIC, or the like, and need not be described in greater detail herein. Similarly, the memory 152 may comprise random memory, read-only memory, flash memory, and the like. A portion of the memory 152 may be integrated into the CPU 150. In general, the CPU 150 receives instructions and data from the memory 152 and performs operations on the data in accordance with the instructions.

The mobile unit 102 also includes a number of conventional I/O devices 154, such a display, keyboard, audio output, video input, and the like. These many possible devices are referred to generically herein as the I/O devices 154.

The mobile unit 102 also has a PLMN transceiver 156. The PLMN transceiver 156 is configured to communicate with the base station 106 via the wireless communication link 108 shown in FIG. 1. As described above, the actual implementation of the PLMN transceiver 156 depends on the particular wireless service provider and the particular communications protocol used by that service provider. The system 100 may operate satisfactorily with any of the various wireless technologies. The data exchanged using the PLMN 104 will be described in greater detail below.

The mobile unit 102 also includes a first short-range transceiver 158 and a second short-range transceiver 160. As discussed above, the short-range transceivers 158-160 may be implemented in accordance with conventional communication protocols, such as, by way of example, Bluetooth. The short-range transceivers 158-160 are used to establish the first and second wireless communication links 124-126, respectively (see FIG. 1) with the authentication station 110. FIG. 2 illustrates the short-range transceivers 158-160 as two separate devices. Some mobile units 102 may indeed include two separate transceivers. In other implementations, a single transceiver may be capable of maintaining multiple air links, such as a first and second wireless communication links 124-126, respectively. In older versions of the mobile unit 102, there may be only a single short-range transceiver (e.g., the short-range transceiver 158). In this embodiment, the mobile unit 102 can sequentially establish the wireless communication links 124-126.

The transceivers 156-160 are coupled to an antenna system 162. Because the PLMN transceiver 156 may operate on frequencies significantly different from those of the short-range transceivers 158-160, the antenna system 162 may comprise multiple antenna elements. However, for the sake of brevity, those are illustrated herein as the antenna system 162.

The various components described above are coupled together by a bus system 166. The bus system 166 may include an address bus, data bus, control bus, power bus, and the like.

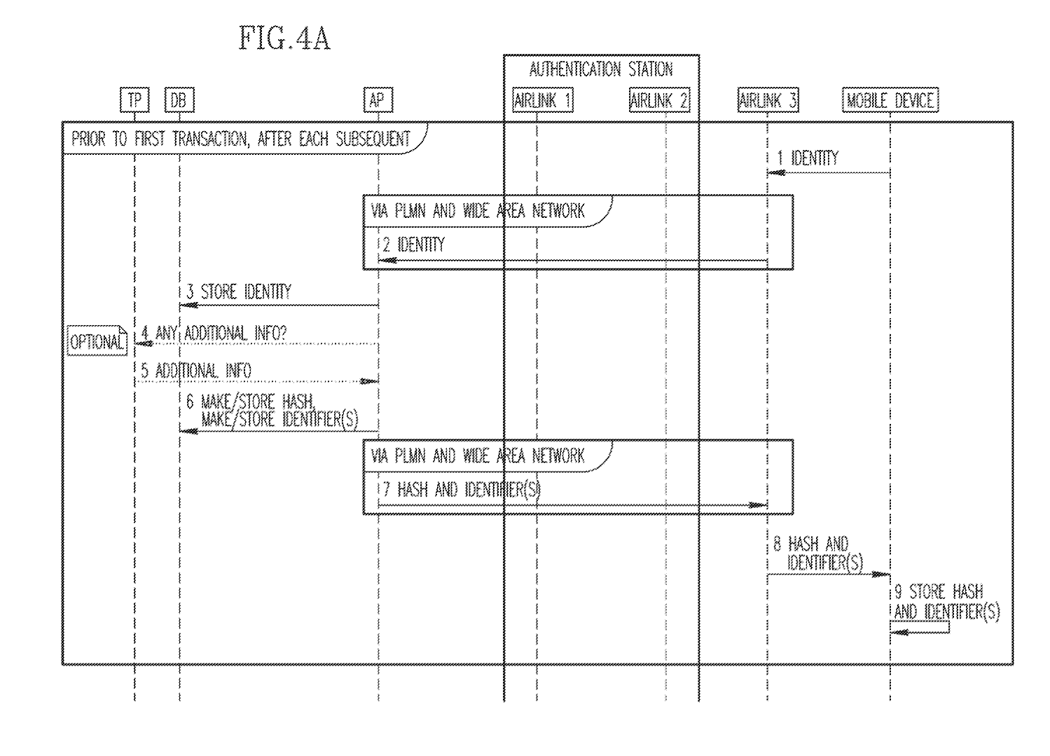

FIG. 3 is a functional block diagram of an exemplary embodiment of the authentication station 110. The authentication station 110 has a CPU 180 and memory 182. As described above with respect to the mobile unit 102, the CPU 180 and memory 182 may be implemented by a variety of known technologies. In general, CPU 180 receives instructions and data from the memory 182 and performs operations on the date in accordance with the instructions.

The authentication station 110 also includes first and second short-range transceivers 186 and 188. The short-range transceivers 186-188 are used to establish the short-range wireless communication links 124-126 respectively, with the mobile unit 102. The short-range transceivers 186-188 are coupled to an antenna system 190. As discussed above with respect to FIG. 2, the mobile unit 102 may include two separate short-range transceivers 158-160, or a single short-range transceiver capable of establishing and maintaining two simultaneous air links (e.g., the first and second wireless communication links 124-126), or, in older versions of the mobile unit, a single short-range transceiver (e.g., the short-range transceiver 158) that can support only a single wireless air link (e.g., either the wireless communication link 124 or the wireless communication link 126) at a given time. Similarly, FIG. 3 illustrates the authentication station 110 as having two transceivers 186-188 to communicate with the mobile unit over the wireless communication links 124-126, respectively. In one embodiment, the transceivers 186-188 may be implemented as two separate short-range transceivers. Alternatively, the authentication station 110 may be implemented with a single short-range transceiver (e.g., the transceiver 186) that is capable of establishing and maintaining simultaneous air links (e.g., the wireless communication links 124 and 126). In yet another embodiment, the authentication station 110 may include only a single transceiver (e.g., the transceiver 186) that is capable of establishing and maintaining only a single air link (e.g., the wireless communication link 124 or the wireless communication link 126) at any given time. The authentication station 110 also includes a network interface controller (NIC) 192 to control communications with the WAN 120 on the communication link 122. Those skilled in the art will appreciate that the NIC 192 is a conventional component that may be implemented in a variety of manners to accommodate the desired connectivity. In one embodiment, the NIC 192 may include an Ethernet interface to connect to the WAN 120.

As will be described in greater detail below, the authentication station 110 will communicate with the mobile unit 102 to derive information therefrom. That information will be relayed to the authentication processor 134 via the WAN 120. If the mobile unit 102 is authenticated by the authentication processor 134, and the transaction processor 130 approves the transaction, the authorization to proceed with the transaction will be transmitted to the authentication station 110 via the WAN 120 and the NIC 192.

The various components of the authentication station 110 are coupled together by a bus system 194. The bus system 194 may include an address bus, data bus, control bus, power bus, and the like.

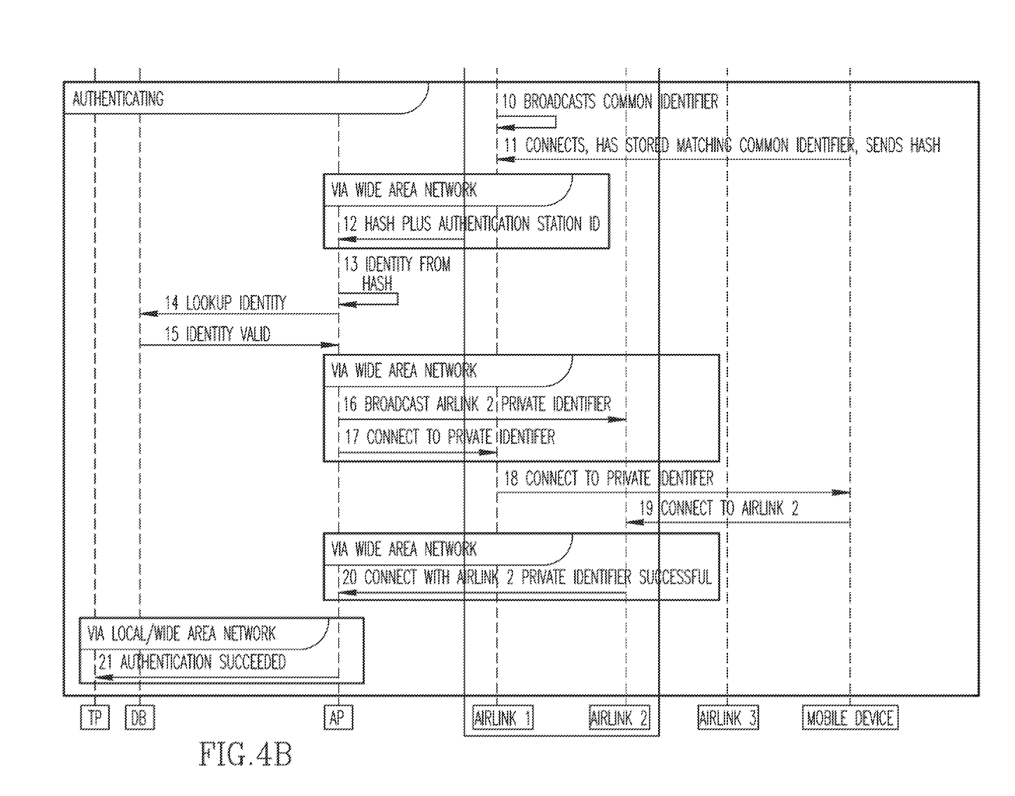

The exchange of data by the various components in FIG. 1 may now be described in greater detail. FIG. 4 illustrates the exchange of data messages between the mobile unit 102 and the authentication processor 134 as well as data message exchanges between the mobile unit 102 and the authentication station 110 and between the authentication station 110 and the authentication processor 134.

FIGS. 4A-4B illustrates data exchanges in two separate processes. In one set of data exchanges shown in FIG. 4A, the mobile unit 102 communicates with the authentication processor 134 via the PLMN 104. This process is performed prior to a first transaction using the mobile unit 102 and after each subsequent transaction. The mobile unit 102 contains an Identity, which is identity data unique to the mobile unit. The Identity may include one or more elements, such as a device ID, IMEI, or the like. The Identity may also include user selected components, such as an email address, password, or the like. The Identity may be a combination of these elements. The Identity may be embedded into hardware components, such as the CPU 180 or firmware, such as the memory 182. In another embodiment, portions of the Identity may be stored in one or more of these components. Prior to any transaction, the mobile unit 102 transmits its Identity to the authentication processor 134 using the PLMN 104. Those skilled in the art will appreciate that the mobile unit 102 must be a registered device with the service provider operating the PLMN 104. The PLMN 104 will not communicate with the mobile unit 102 if it is an unregistered device or if it is an illegal device that is attempting to mimic or “spoof” the real mobile unit 102.

In an exemplary embodiment, the Identity is transmitted from the mobile unit 102 to the authentication processor 140 prior to initiating any transaction at the authentication station 110. As will be explained in greater detail below, following any transaction, the Identity is retransmitted to the authentication processor 134 for the next subsequent transaction.

The authentication processor 134 transmits the Identity to the database 138 for storage. The authentication processor 134 may also provide additional information about the user. For example, it could include flags regarding the type of user (e.g., individual user, corporate user, and the like) or any other information related to the mobile unit 102. That information is also stored in the database 138.

The authentication processor 134 uses the identity to create a Hash and Identifiers, which are also stored in the database 138. Those skilled in the art will appreciate that a Hash is a cryptographic Hash function or similar method of encrypting the Identity.

The authentication processor 134 also creates security data in the form of Identifiers. The Identifiers are data strings that are broadcast by the authentication station 110 over the short-range communication links 124-126. The Identifiers identify an air link to devices (e.g., the mobile unit 102) listening for an Identifier and for an air link. In the system 100, there are two types of Identifiers. The first type of Identifier, used in the short-range communication link 124, is a Common Identifier (e.g., FinancialProcessingNetwork). The authentication station 110 broadcasts the Common Identifier over the short-range communication link 124 for detection by the mobile unit 102. The Common Identifier may remain fixed, or may be changed from time to time either administratively or by the authentication processor 134. It may be used by multiple devices for multiple transactions. In contrast, the second type of Identifier is a Private Identifier, which is unique to each authentication, and is dynamically assigned by the authentication processor 134. In an exemplary embodiment, the Private Identifier is comprised of a random combination of alphanumeric characters (e.g., b4m73xxfxlc24). The Private Identifier is broadcast only for the duration necessary for the mobile unit 102 to establish a connection and exchange any (optional) data. The Hash, and Identifiers are relayed back from the database 138 to the authentication processor 134 and transmitted back to the mobile unit 102 via the PLMN 104. The mobile unit 102 stores the Hash and Identifiers in the memory 182. At this point, the mobile unit 102 contains information, in the form of a Common Identifier, a Private Identifier and a Hash of its Identity. These data are stored in the mobile unit 102 in preparation for a future transaction. Those skilled in the art will appreciate that, at this point in time, only the mobile unit 102 and the authentication processor 134 know the Hash and the Identifiers.

Following each transaction, this process is repeated so that the mobile unit 102 always contains a different Private Identifier for each transaction. This reduces the possibility of an unauthorized device mimicking the Identity of the mobile unit 102. In one embodiment, the Hash can also be changed for each transaction thus providing an additional layer of security in the authentication process.

The data, such as the Hash and the Identifiers are delivered to the mobile unit 102 via a first wide-area network (e.g., the PLMN 104) and are safely stored in the mobile unit. This data may now be used for authentication during a transaction. As shown in FIG. 4B, the authentication station 110 broadcasts the Common Identifier on the wireless communication link 124. The mobile unit 102 detects the Common Identifier and connects to the authentication station 110 via the wireless communication link 124. The mobile unit 102 makes the connection to the authentication station because of the matching Common Identifiers. Once connected, the mobile unit 102 transmits the Hash to the authentication station 110 via the wireless communication link 124.

In response, the authentication station 110 transmits an authentication station ID and the received Hash to the authentication processor 134 via the WAN 120. The authentication station ID is a unique permanent Identifier for the authentication station. The authentication station ID can be compared to a list of valid authentication station IDs as a further means of security during the authentication process. In addition, the authentication station ID can be used in a confirmation process to determine the precise location of a financial transaction if questions arise at a subsequent time. The authentication processor 134 derives the Identity from the received Hash and looks up the Identity in the database 138. If the Identity derived from the Hash is valid, the database 138 returns an indicator that the Identity is valid. If not, the authentication fails and the transaction cannot proceed.

In response to a valid Identity, the authentication processor 134 transmits the Private Identifier to the authentication station 110 via the WAN 120. In response, the authentication station 110 transmits the Private Identifier on the wireless communication link 126. At the same time, the authentication station 110 instructs the mobile unit 102, using the wireless communication link 124, to connect to a Private Identifier.

In response to the instruction, the mobile unit 102 detects the Private Identifier broadcast from the authentication station 110 and connects to the authentication station via the wireless communication link 126. If the mobile unit 102 and the authentication station 110 are capable of simultaneously maintaining both air links (e.g., the wireless communication links 124 and 126 in FIG. 1), these processes can occur simultaneously. However, if one of the devices (e.g., either the mobile unit 102 or the authentication station 110) is only capable of maintaining a single short-range air link, these processes can occur sequentially. That is, the authentication station 110 can use the first air link (e.g., the wireless communication link 124) to instruct the mobile unit 102 to communicate using the Private Identifier. Following that instruction, the authentication station may terminate the wireless communication link 124 and broadcast the Private Identifier on the wireless communication link 126. Thus, in one embodiment, both the wireless communication links 124 and 126 can be maintained simultaneously. However, in an alternative embodiment, the same level of security can be achieved using the wireless communication links 124 and 126 in sequence so that only one short-range wireless communication link is active at any given time.

During the transaction, the authentication station 110 receives the Private Identifier via the WAN 120. The mobile unit 102 has previously received the Private Identifier via the PLMN 104 in the process described above. As noted above, the Private Identifier is unique for that mobile unit 102 and that particular transaction. In turn, the authentication station 110 has now received the matching Private Identifier, which will be valid only for the ongoing transaction. Thus, the possible interception of the Private Identifier by a third party will not be useful in subsequent financial transactions because the Private Identifier and, in one embodiment, the Hash will be altered upon completion of the current transaction.

In response to the command to connect to the Private Identifier, the mobile unit 102 connects to the authentication station 110 via the wireless communication link 126. Upon connection using the Private Identifier, the authentication station 110 transmits a message to the authentication processor 134 via the WAN 120 to indicate that the connection using the Private Identifier was successful. This means the authentication of the mobile unit 102 has been successfully completed.

With the successful completion of the authentication process, the authentication processor 134 transmits a message to the transaction processor 130 that the authentication was successful. The transaction processor 130 operates in a conventional manner to determine whether the transaction itself can proceed. That is, the transaction processor 130 can check the amount of the transaction, credit limits, and the like to determine whether or not to allow the transaction to proceed.

Thus, the system 100 uses multiple different communication links and different networks to uniquely identify the mobile unit 102 and to pre-send a Private Identifier (and, optionally the Hash) that will be uniquely determined for each transaction. Because different portions of the data for the transaction are transmitted at different times and via different communication pathways, it makes it difficult to intercept data and mimic the mobile unit.

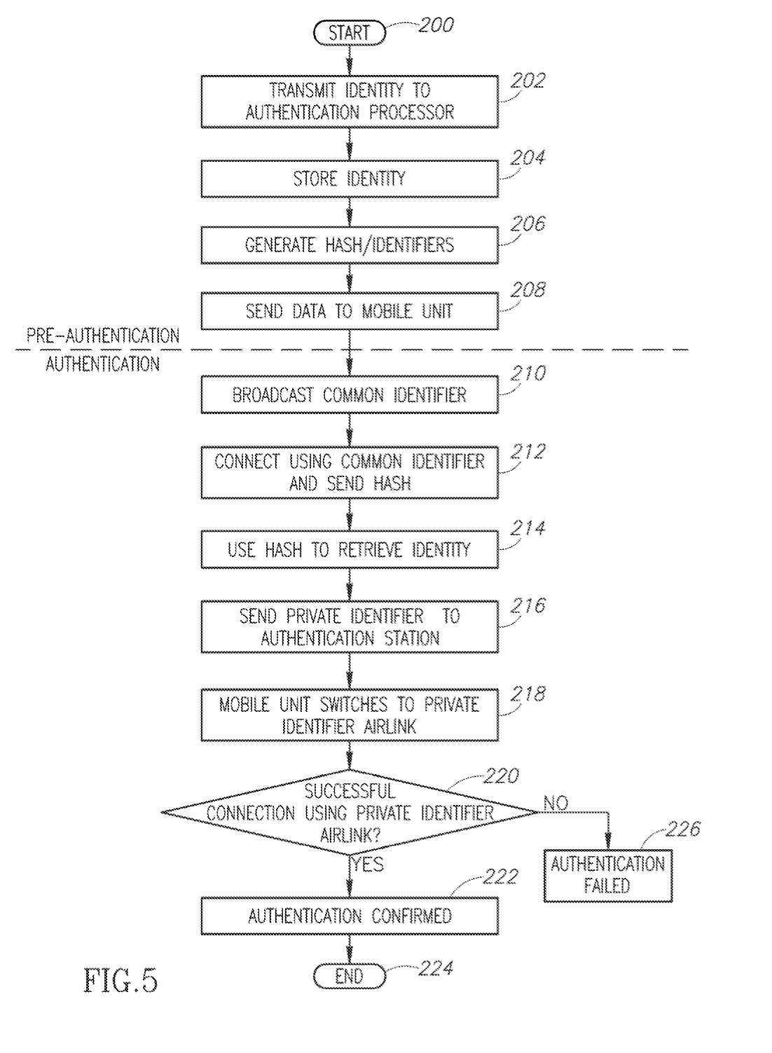

FIG. 5 is a flow chart illustrating an exemplary embodiment of the system 100. At a start 200, the mobile unit 102 contains an Identity, but has not received information from the authentication processor 134. In step 202, the mobile unit 102 transmits its Identity to the authentication processor 134 via the PLMN 104. As previously noted, the PLMN 104 may communicate directly with the authentication processor 134 using the communication link 142 or via the WAN using the communication link 144.

In step 204, the authentication processor 134 receives the Identity and stores the Identity in the database 138. The database 138 stores the Identity and, in step 206, generates the Hash and Identifiers. The Hash and Identifiers are also stored in the database 138. In step 208, the authentication processor 134 transmits the Hash and the Identifiers to the mobile unit 102 using the PLMN 104. As previously discussed, these steps all occur in a pre-authentication process. That is, the Hash and Identifiers are generated, based on the Identity of the mobile unit 102 and stored in the mobile unit prior to the initiation of any transaction.

The following steps describe the authentication process during a transaction. In step 210, the authentication station 110 broadcasts the Common Identifier. When the mobile unit 102 is within a short range of the authentication station 110, it detects the Common Identifier broadcast by the authentication station and connects with the authentication station via the wireless communication link 124. Upon connection, the mobile unit 102 transmits the Hash to the authentication station 110 using the wireless communication link 124.

The authentication station 110 transmits the Hash received from the mobile unit 102, and an authentication station ID, to the authentication processor 134 via the WAN 120. In step 214, the authentication processor 134 uses the Hash to derive the Identity of the mobile unit 102 and looks up the mobile unit Identity in the database 138. If the Hash is a bogus set of data from an unauthorized device, it will not produce the correct Identity and the authentication process will fail. As an additional security measure, those skilled in the art will appreciate that the mobile unit 102 must be in close proximity with the authentication station 110 to detect the Common Identifier and to transmit its Hash thereto. Because the Hash has been previously transmitted to the mobile unit 102 via the PLMN 104, an unauthorized user would have to intercept that Hash and also be in proximity with the authentication station 110. These independent processes make that prospect exceedingly difficult.

In step 216, the authentication processor 134 sends the Private Identity to the authentication station 110 using the WAN 120. Furthermore, the authentication processor 134 verifies the authentication station ID on a list of valid authentication stations. In addition to the Private Identity transmitted to the authentication station 110, the authentication processor 134 transmits a command instructing the mobile unit 102 to connect to the Private Identifier. The authentication station 110 transmits the connect command to the mobile unit 102 via the wireless communication link 124.

In step 218, the mobile unit 102 switches to the Private Identifier wireless communication link 126.

In step 218, the mobile unit responds to the command and switches to the Private Identifier air link using the wireless communication link 126. In decision 220, the authentication station 110 determines whether it has successfully connected with the mobile unit 102 using the Private Identifier air link. If the result of decision 220 is YES, the authentication station 110 sends a success message to the authentication processor 134 and, in step 222, the authentication processor transmits an “authentication confirmed” message to the transaction processor 130. The authentication process ends at step 224. If the result of decision 220 is NO, the authentication fails at step 226.

As previously discussed, the mobile unit 102 communicates with the authentication processor 134 and completes steps 202-208 prior to any transaction. Similarly, upon successful completion of the authentication process in step 224, steps 202-208 may be repeated so that the mobile unit 102 now stores a new Hash and new Identifiers (a new Common Identifier and a new Private Identifier).

Those skilled in the art will appreciate that the use of two different wide area networks (i.e., the PLMN 104 and the WAN 120) at two different times, as well as the communication via different air links (i.e., the Common Identifier air link and the Private Identifier air link) makes it virtually impossible for an unscrupulous individual to mimic the mobile unit 102 or the authentication station 110. Thus, the system 100 provides improved authentication and security for financial transactions using the mobile unit 102.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A method for the authentication of a transaction using a wireless communication device, comprising:
prior to a transaction, transmitting identity data from the wireless communication device to an authentication processor using a first wide-area network (WAN);
storing the received identity data;
using the identity data to generate security data and identifiers;
transmitting the security data and the identifiers to the wireless communication device using the first WAN;
during a transaction, establishing a first short-range wireless connection between the wireless communication device and an authentication station;
transmitting the security data from the wireless communication device to the authentication station via the first short-range wireless connection;
relaying the security data from the authentication station to the authentication processor using a second WAN;
using the security data to confirm the identity of the wireless communication device and, if the identity is confirmed, transmitting the identifiers to the authentication station using the second WAN; and
establishing a second short-range wireless connection between the wireless communication device and the authentication station using a portion of the identifiers to thereby complete the authentication.

2. The method of claim 1 wherein using the identity data to generate security data comprises generating a hash of the identity data.

3. The method of claim 2 wherein using the security data to confirm the identity of the wireless communication device comprises using the hash to regenerate the identity data and looking up the stored identity data to determine if it matches the regenerated identity data.

4. The method of claim 1 wherein the first WAN is a public land mobile network (PLMN).

5. The method of claim 1 wherein the second WAN is the Internet.

6. The method of claim 1 wherein the identifiers comprise first and second identifiers, and establishing the first short-range wireless connection between the wireless communication device and the authentication station utilizes the first identifier, and establishing the second short-range wireless connection between the wireless communication device and the authentication station utilizes the second identifier.

7. The method of claim 6 wherein the second identifier is valid only for a single transaction.

8. The method of claim 1 wherein the security is valid only for a single transaction.

9. The method of claim 1 wherein the first and second short-range wireless connection are Bluetooth connections.

10. A method for the authentication of a transaction using a wireless communication device, comprising:
prior to a transaction, receiving identity data from the wireless communication device to an authentication processor using a first wide-area network (WAN);
storing the received identity data;
using the identity data to generate security data and identifiers;
transmitting the security data and the identifiers to the wireless communication device using the first WAN;
during a transaction, establishing a first short-range wireless connection between the wireless communication device and an authentication station;
receiving the security data from the wireless communication device via the first short-range wireless connection;
relaying the security data from the authentication station to the authentication processor using a second WAN;
using the security data to confirm the identity of the wireless communication device and, if the identity is confirmed, transmitting the identifiers to the authentication station using the second WAN; and
establishing a second short-range wireless connection between the wireless communication device and the authentication station using a portion of the identifiers to thereby complete the authentication.

11. The method of claim 10 wherein using the identity data to generate security data comprises generating a hash of the identity data and wherein using the security data to confirm the identity of the wireless communication device comprises using the hash to regenerate the identity data and looking up the stored identity data to determine if it matches the regenerated identity data.

12. The method of claim 10 wherein the identifiers comprise first and second identifiers, and establishing the first short-range wireless connection between the wireless communication device and the authentication station utilizes the first identifier, and establishing the second short-range wireless connection between the wireless communication device and the authentication station utilizes the second identifier.

13. The method of claim 12 wherein the second identifier is valid only for a single transaction.

14. The method of claim 10 wherein the security is valid only for a single transaction.

15. A system for the authentication of wireless transactions using a wireless communication device having first and second wireless interfaces, the system comprising:
an authentication station having a wireless interface configured to communicate with the first wireless interface of the wireless communication device;
a network interface coupled to the authentication station and configured to communication with a first wide-area network (WAN);
an authentication processor communicatively coupled to the first WAN and to a second WAN; and
a data storage structure communicatively coupled to the authentication processor,
wherein the authentication processor is configured to receive identity data from the wireless communication device via the second wireless interface of the wireless communication device and the second WAN and to generate identifiers and security data related to the identity data of the wireless communication device and to transmit the identifiers and security data to the wireless communication device via the second WAN and the second wireless interface of the wireless communication device, the authentication station being configured to establish a first short-range communication link with the wireless communication device and to receive the security data therefrom, the authentication station being configured to transmit the received security data to the authentication processor using the first WAN, the authentication processor being further configured to use security data received from the authentication station to confirm the identity data of the wireless communication device and, if the identity is confirmed, to send a private identifier to the authentication station via the first WAN, the authentication station being further configured to establish a second short-range communication link with the wireless communication device using the private identifier and to report a successful authentication if the second short-range communication link with the wireless communication device using the private identifier is successfully established.

16. The system of claim 15 wherein the authentication station wireless interface configured to communicate with the first wireless interface of the wireless communication device is a Bluetooth interface.

17. The system of claim 15 wherein the first WAN is the Internet.

18. The system of claim 15 wherein the second WAN is a public land mobile network (PLMN).

19. The system of claim 15 wherein the security data related to the identity data of the wireless communication device is a Hash code generated by the authentication processor.

20. The system of claim 15 for use in authentication of a transaction wherein the authentication processor is configured to receive the identity data from the wireless communication device, generate the identifiers and the security data, and to transmit the identifiers and security data to the wireless communication device prior to the initiation of the transaction.

21. The system of claim 20 for use in authentication of a transaction wherein the authentication processor is configured to receive the identity data from the wireless communication device, generate new identifiers and new security data, and to transmit the new identifiers and new security data to the wireless communication device upon completion of the transaction.

22. The system of claim 15 for use in authentication of a transaction wherein the authentication station is configured to establish the first short-range communication link receive the security data, transmit the received security data to the authentication processor using the first WAN during the transaction, and wherein the authentication processor is configured to confirm the identity data of the wireless communication device and, if the identity is confirmed, send the private identifier to the authentication station via the first WAN, and wherein the authentication station is configured to establish the second short-range communication link using the private identifier and to report the successful authentication if the second short-range communication link with the wireless communication device using the private identifier is successfully established during the transaction.

23. The system of claim 15, further comprising a transaction processor communicatively coupled to the authentication processor and configured to receive an authentication verification message therefrom, the transaction processor being further configured to authorize a transaction.
